(19) United States
(12) Patent Application Publication
(10) Pub. No.: US 2024/0422809 A1
(43) Pub. Date: Dec. 19, 2024

(54) ORBITAL ANGULAR MOMENTUM-BASED SHARED CHANNEL TRANSMISSION METHOD AND APPARATUS

(71) Applicant: Beijing Xiaomi Mobile Software Co., Ltd., Beijing (CN)

(72) Inventors: Liangang CHI, Beijing (CN); Gaoming DUAN, Beijing (CN)

(21) Appl. No.: 18/703,283

(22) PCT Filed: Oct. 22, 2021
(86) PCT No.: PCT/CN2021/125797

§ 371 Date: Apr. 19, 2024

(51) Int. Cl. H04W 72/53

(52) U.S. Cl. CPC H04W 72/53

(57) ABSTRACT

A method for transmitting shared channel based on orbital angular momentum includes: a network device determining, based on the current channel information, a target OAM mode for transmitting a shared channel, and transmitting a shared channel according to the target OAM mode.

### BACKGROUND OF THE INVENTION

With the continuous development of wireless communication, a demand for a communication capability is also increasing. For future application scenarios such as augmented reality (AR)/virtual reality (VR), the Internet of Vehicles, and the Internet of Things, ultra-high speed, ultra-low latency, and ultra-large bandwidth communication has become the norm. In order to meet this demand, more and more high-frequency bands such as a millimeter wave band and a terahertz wave band are being developed. However, as a limited resource, a frequency spectrum is also becoming increasingly scarce. Thus, in addition to developing higher frequency bands, seeking a communication technology with higher frequency spectrum efficiency has become an urgent task. How to choose an appropriate combination of modes as a transmission mode to meet service requirements of a shared channel has become an urgent problem to be solved.

### SUMMARY OF THE INVENTION

In a first aspect, an example of the disclosure provides a method for transmitting shared channel based on orbital angular momentum, performed by a network device, and including:
determining, based on current channel information, a target orbital angular momentum (OAM) mode for transmitting a shared channel; and
transmitting the shared channel according to the target OAM mode.

In a second aspect, an example of the disclosure provides another method for transmitting shared channel based on orbital angular momentum, performed by a terminal device, and including:
receiving target orbital angular momentum (OAM) mode information sent by a network device;
determining a corresponding target OAM mode according to the target OAM mode information; and
transmitting the shared channel according to the corresponding target OAM mode.

In a third aspect, an example of the disclosure provides a communication apparatus, including a processor and a memory, and a computer program is stored in the memory. The processor executes the computer program stored in the memory, such that the communication apparatus performs the method described in the first aspect above.

In a fourth aspect, an example of the disclosure provides a communication apparatus, including a processor and a memory, and a computer program is stored in the memory. The processor executes the computer program stored in the memory, such that the communication apparatus is configured to:
receive target orbital angular momentum (OAM) mode information sent by a network device;
determine a corresponding target OAM mode according to the target OAM mode information; and
transmit a shared channel according to the target OAM mode.

### BRIEF DESCRIPTION OF DRAWINGS

FIG. 1 is a schematic diagram of an architecture of a communication system provided by an example of the disclosure;

FIG. 2 is a schematic flow diagram of a method for transmitting shared channel based on orbital angular momentum provided by an example of the disclosure;

FIG. 3 is a schematic flow diagram of another method for transmitting shared channel based on orbital angular momentum provided by an example of the disclosure;

FIG. 4 is a schematic flow diagram of yet another method for transmitting shared channel based on orbital angular momentum provided by an example of the disclosure;

FIG. 5 is a flow diagram of yet another method for transmitting shared channel based on orbital angular momentum provided by an example of the disclosure;

FIG. 6 is a schematic flow diagram of another method for transmitting shared channel based on orbital angular momentum provided by an example of the disclosure;

FIG. 7 is a schematic flow diagram of yet another method for transmitting shared channel based on orbital angular momentum provided by an example of the disclosure;

FIG. 8 is a schematic flow diagram of another method for transmitting shared channel based on orbital angular momentum provided by an example of the disclosure;

FIG. 9 is a schematic structural diagram of a communication apparatus provided by an example of the disclosure;

FIG. 10 is a schematic structural diagram of another communication apparatus provided by an example of the disclosure.

### DETAILED DESCRIPTION OF THE INVENTION

Examples of the disclosure are described below in detail. Instances of the examples are shown in accompanying drawings. The same or similar reference numbers represent the same or similar elements or elements with the same or similar functions from beginning to end. The examples described below with reference to the accompanying drawings are merely examples, aim to explain the disclosure, and cannot be understood as a limitation to the disclosure. In the description of the disclosure, unless otherwise specified, “/” represents or, for example, A/B may represent A or B; and “and/or” in this text is merely an association relationship to describe an association object, and represents that there may be three kinds of relationships, for example, A and/or B, may represent: A exists alone, A and B exist at the same time, and B exists alone.

A term “including” and any variations of this term in the specification and claims of the disclosure are intended to cover but not exclusively contain, for example, a process, method, system, product or device containing a series of steps or units is not necessarily limited to those steps or units expressly listed, but may include other steps or units not expressly listed or inherent to these processes, methods, products or devices. In addition, in the examples of the disclosure, a word “example” or “for example” is used to being represented as an example, example illustration or description. Any example or design solution described as the “example” or “for example” in the examples of the disclosure should not be explained being more preferred or having more advantages than other examples or design solutions. Exactly speaking, the word “example” or “for example” is used to be aimed at presenting the relevant concept in a specific mode.

It needs to be noted that with the continuous development of wireless communication, a demand for a communication capability is also increasing. For future application scenarios such as augmented reality (AR)/virtual reality (VR), the Internet of Vehicles, and the Internet of Things, ultra-high speed, ultra-low latency, and ultra-large bandwidth communication has become the norm. In order to meet this demand, more and more high-frequency bands such as a millimeter wave band and a terahertz wave band are being developed. However, as a limited resource, a frequency spectrum is also becoming increasingly scarce. Thus, in addition to developing higher frequency bands, seeking a communication technology with higher frequency spectrum efficiency has become an urgent task. In 1992, the concept of a vortex electromagnetic wave was first proposed, making the vortex electromagnetic wave link to an orbital angular momentum (OAM). The OAM, independent of a traditional modulation dimension such as a phase, a frequency, and polarization, is considered a new modulation dimension. Moreover, OAM modes carried by the vortex electromagnetic wave theoretically have an infinite quantity, and OAM beams with different integer eigenvalues are orthogonal to each other. In theory, a frequency spectrum utilization ratio may be infinitely increased.

Initially, due to the existence of a beam divergence angle of the OAM, the OAM is extensively studied in optical communication. The Venice Lake experiment in 2011 proved that the OAM may also be used to send information in radio frequency communication. At present, there are two main ways to use the OAM to send the information: OAM shifter keying (OAM-SK) and OAM division multiplexing (OAM-DM). The OAM communication has the characteristics that generation and demodulation methods are simple without the need for complex reception and demodulation algorithms; and different OAM beams are orthogonal to each other, theoretically resulting in an infinite number of modes and ultra-high frequency spectrum efficiency.

The most common wireless OAM transceiving system is an OAM communication system based on a uniform circular array (UCA), and this system needs axis alignment of a transceiving antenna. When there is an axis deviation angle between transceivers, a receiver will generate modal crosstalk, leading to an increase in a bit error rate and a decrease in system performance. The transmission performance of different modes is affected differently by channel parameters, thus signal to interference plus noise ratios (SINRs) of different modes are different. Hence, how to choose an appropriate combination of modes as a transmission mode to meet the service requirements of a shared channel has become an urgent problem to be solved.

Based on the above problem, the disclosure provides a method and apparatus for transmitting shared channel based on orbital angular momentum, applicable to application scenarios such as augmented reality (AR)/virtual reality (VR), the Internet of Vehicles, and the Internet of Things. A UCA-based OAM communication system has intermodal interference, and main intermodal interference varies with different channel information, such that different transmission modes may be flexibly selected to form a mode combination to bear information, thus improving system reliability.

The disclosure relates to the technical field of communications, in particular to a method and apparatus for transmitting shared channel based on orbital angular momentum.

In order to better understand the method for transmitting shared channel based on orbital angular momentum disclosed in an example of the disclosure, the following will first describe a communication system applicable to the example of the disclosure.

Please refer to FIG. 1, and FIG. 1 is a schematic diagram of an architecture of a communication system provided by an example of the disclosure. The communication system may include, but is not limited to one network device and one terminal device. The number and form of devices shown in FIG. 1 are merely for example and do not constitute a limitation on the example of the disclosure. In practical applications, the communication system may include two or more network devices and two or more terminal devices. The communication system shown in FIG. 1 includes one network device 101 and one terminal device 102 as an example.

It needs to be noted that the technical solutions of the example of the disclosure may be applied to various communication systems, such as a long term evolution (LTE) system, a 5th generation (5G) mobile communication system, a 5G new radio (NR) system, or other future new mobile communication systems. It further needs to be noted that a Sidelink in the example of the disclosure may further be referred to as a Side-line Link or a direct link.

The network device 101 in the example of the disclosure is an entity on a network side for transmitting or receiving a signal. For example, the network device 101 may be an evolved NodeB (eNB), a transmission reception point (TRP), a next generation NodeB (gNB) in an NR system, base stations in other future mobile communication systems, or an access node in a wireless fidelity (WiFi) system, etc. A specific technology and a specific device form adopted by the network device are not limited by the example of the disclosure. The network device provided by the example of the disclosure may be composed of a central unit (CU) and a distributed unit (DU), where the CU may also be referred to as a control unit. A CU-DU structure may separate the network device, such as a protocol layer of the base station, with part of protocol layer functions placed in the CU for centralized control, and the remaining or all protocol layer functions distributed in the DU, and the DU is centrally controlled by the CU.

The terminal device 102 in the example of the disclosure is an entity on a user side for receiving or transmitting a signal, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home and the like. A specific technology and a specific device form adopted by the terminal device are not limited by the example of the disclosure.

In sidelink communication, there are four types of sidelink transmission modes. A sidelink transmission mode 1 and a sidelink transmission mode 2 are used for device-to-device (D2D) communication with the terminal device. A sidelink transmission mode 3 and a sidelink transmission mode 4 are used for Vehicle to everything (V2X) communication. When the sidelink transmission mode 3 is used, resource allocation is scheduled by a network device 101. The network device 101 may send resource allocation information to a terminal device 102, and then the terminal device 102 allocates resources to another terminal device, so that the other terminal device may send information to the network device 101 through the allocated resources. In the V2X communication, a terminal device with a good signal or high reliability may be used as the terminal device 102. The terminal device mentioned in the example of the disclosure may refer to the terminal device 102, or the terminal device mentioned in the example of the disclosure may be referred to as a relay.

It may be understood that the communication system described by the example of the disclosure is for the purpose of illustrating the technical solutions of the example of the disclosure more clearly, and does not constitute a limitation to the technical solutions provided by the example of the disclosure. Those ordinarily skilled in the art may know that with evolution of the system architecture and occurrence of a new service scenario, the technical solutions provided by the example of the disclosure are also applicable to the similar technical problem.

The method and apparatus for transmitting shared channel based on orbital angular momentum provided by the disclosure are introduced below in detail with reference to the accompanying drawings.

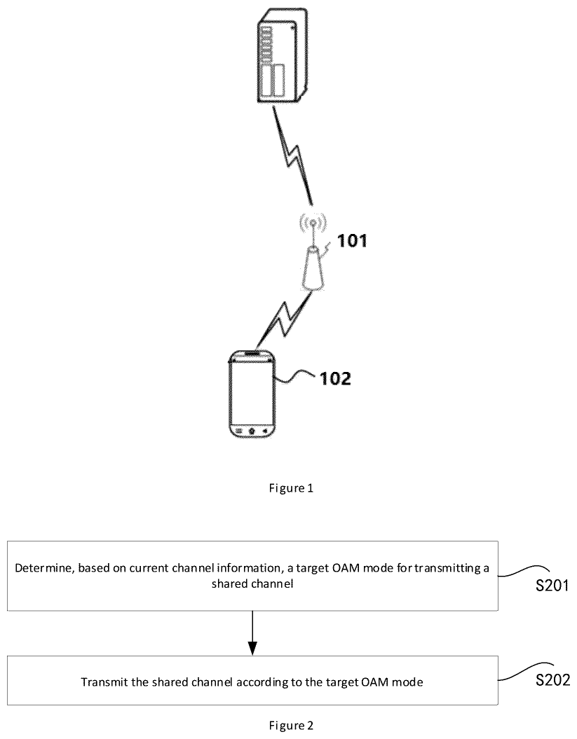

Please refer to FIG. 2, and FIG. 2 is a schematic flow diagram of a method for transmitting shared channel based on orbital angular momentum provided by an example of the disclosure. It needs to be noted that the method for transmitting shared channel based on orbital angular momentum according to the example of the disclosure may be performed by a network device. As shown in FIG. 2, the method may include, but is not limited to the following steps.

Step S201: a target OAM mode for transmitting a shared channel is determined based on current channel information.

In an example, the current channel information of the shared channel between the network device and a terminal device may be determined, and the target OAM mode for transmitting the shared channel may be determined based on the current channel information.

In an example, the shared channel may be divided into a physical downlink shared channel (PDSCH) and a physical uplink shared channel (PUSCH). For the PDSCH, a target OAM mode for transmitting the PDSCH may be determined based on current channel information of the PDSCH. For the PUSCH, a target OAM mode for transmitting the PUSCH may be determined based on current channel information of the PUSCH.

Step S202: the shared channel is transmitted according to the target OAM mode.

In an example, after determining the target OAM mode for transmitting the shared channel, the shared channel may be transmitted according to the target OAM mode. For example, for the PDSCH, the PDSCH may be transmitted according to a first OAM mode in response to determining that the target OAM mode for transmitting the PDSCH is the first OAM mode, that is to say, PDSCH information may be carried through the first OAM mode. For another example, for the PUSCH, the PUSCH may be transmitted according to a second OAM mode in response to determining that the target OAM mode for transmitting the PUSCH is the second OAM mode, that is to say, PUSCH information may be carried through the second OAM mode.

By implementing the example of the disclosure, different transmission modes may be flexibly selected based on the current channel information of the shared channel to form a mode combination to bear shared channel information, thus improving system reliability.

It needs be noted that due to the fact that the shared channel is divided into the physical downlink shared channel (PDSCH) and the physical uplink shared channel (PUSCH), the configuration modes of the OAM mode may also vary for different shared channels. In order to facilitate those skilled in the art having a clearer understanding of how to choose an appropriate mode combination as a transmission mode to meet the service requirements of the shared channel in the disclosure, the following will describe the physical downlink shared channel and the physical uplink shared channel respectively.

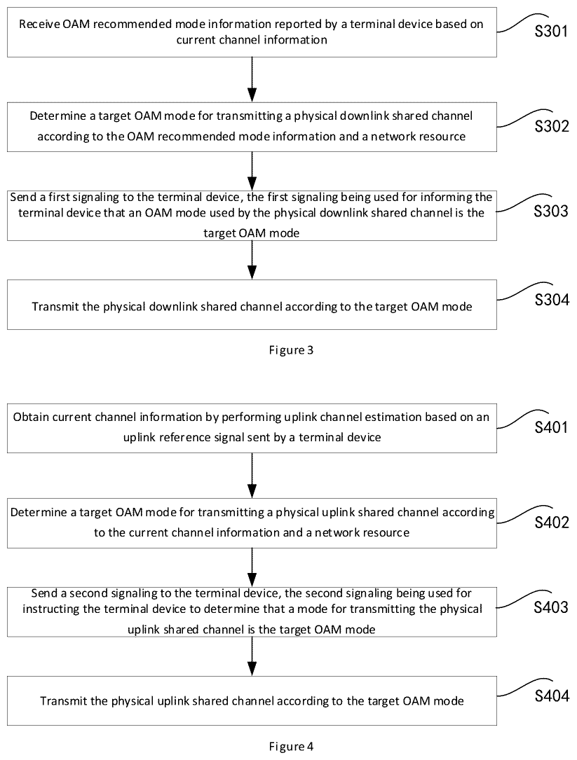

Please refer to FIG. 3, and FIG. 3 is a schematic flow diagram of another method for transmitting shared channel based on orbital angular momentum provided by an example of the disclosure. It needs to be noted that the method for transmitting shared channel based on orbital angular momentum according to the example of the disclosure may be performed by a network device. The example of the disclosure is applied to a physical downlink shared channel (PDSCH) scenario, that is, the example of the disclosure describes how to configure an OAM mode for a PDSCH. As shown in FIG. 3, the method may include, but is not limited to the following steps.

Step S301: OAM recommended mode information reported by a terminal device based on current channel information is received.

In an example, the network device may send a downlink reference signal to the terminal device, and the downlink reference signal may be used for instructing the terminal device to perform downlink channel estimation to obtain the current channel information, and to select OAM recommended mode information corresponding to the current channel information. The network device may receive the OAM recommended mode information reported by the terminal device. The downlink reference signal may be a channel state information (CSI)-reference signal (RS), or other downlink reference signals, which is not specifically limited in the disclosure.

As an example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select the OAM recommended mode information that is suitable for the current channel information. The OAM recommended mode information may be understood as recommending the network device to use the OAM mode information to configure an OAM mode of the PDSCH, so that the configuration-based OAM mode carries the PDSCH information. The terminal device may send the OAM recommended mode information determined based on the current channel information to the network device, so that the network device may configure the OAM mode of the physical downlink shared channel by referring to the OAM recommended mode information sent by the terminal device.

In some examples of the disclosure, the OAM recommended mode information may include at least one of the following:
1) an OAM mode number and/or an OAM mode set; or
2) an OAM mode number and/or an index of the OAM mode set.

As an example, the OAM recommended mode information, recommended by the terminal device, received by the network device may be the OAM mode number, or may be the OAM mode set, or may further be the OAM mode number and the OAM mode set.

For example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select the OAM mode number n that is suitable for the current channel information. That is, the OAM mode number n is a mode number n recommended by the terminal device to the network device for transmission, n<N, where N is the number of antenna arrays at a transmitting end.

For another example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select an OAM mode value that is suitable for the current channel information. The OAM mode value is an OAM mode value recommended by the terminal device to the network device for use, for example, [−4, −3, −2, −1, 0, 1, 2, 3], and a set of the OAM mode value is the OAM mode set above.

In an example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select the OAM mode number n and the OAM mode value that are suitable for the current channel information. The OAM mode number n is the mode number n recommended by the terminal device to the network device for transmission, n<N, where N is the number of the antenna arrays at a transmitting end. The OAM mode value is the OAM mode value recommended by the terminal device to the network device for use.

As another example, the OAM recommended mode information, recommended by the terminal device, received by the network device may be the OAM mode number, or may be an index of the OAM mode set, or may further be the OAM mode number and an index of the OAM mode set. To save signaling overheads, an index number may be set for each set of the OAM mode value. In this way, when the terminal device sends the OAM recommended mode information to the network device, an index corresponding to the OAM mode set recommended for use may be sent to the network device, so that the network device may understand which OAM mode set or sets are recommended to use by the terminal device based on the index.

Step S302: a target OAM mode for transmitting the physical downlink shared channel is determined according to the OAM recommended mode information and a network resource.

In an example, the network device may determine the target OAM mode for transmitting the physical downlink shared channel based on the network resource and the OAM recommended mode information reported and suggested by the terminal device. The target OAM mode determined by the network device may not necessarily be the same as the OAM mode recommended by the terminal device.

In order to make the configured OAM mode more in line with the actual situation, in an example, the network device may determine the target OAM mode for transmitting the physical downlink shared channel according to the OAM recommended mode information and the network resource. That is to say, the network device may configure an OAM mode actually used by the physical downlink shared channel (PDSCH) according to situations such as the OAM recommended mode information reported by the terminal device and the network resource. The network resource may be understood as scheduling of a multi-modal resource by the network device in consideration of multi-user communication.

In an example, the target OAM mode for transmitting the physical downlink shared channel may further be determined according to the OAM recommended mode information, the network resource and a service requirement. That is to say, the network device may configure an OAM mode actually used by the physical downlink shared channel (PDSCH) according to the situations such as the OAM recommended mode information reported by the terminal device, the service requirement and the network resource. The network resource may be understood as scheduling of the multi-modal resource by the network device in consideration of the multi-user communication. The service requirement may be understood as a need of the service for a speed and/or a block error rate (BLER).

That is to say, the network device determines the target OAM mode for transmitting the physical downlink shared channel based on a scheduling situation of the multi-modal resource by the multi-user communication, the need of the service for the speed and/or the BLER, and the recommended OAM mode information reported and suggested by the terminal device.

For example, taking an example that the OAM mode value recommended by the terminal device to the network device for use is [−4, −3, −2, −1, 0, 1, 2, 3], the network device may determine the target OAM mode for transmitting the physical downlink shared channel according to the network resource, the OAM recommended mode information reported and suggested by the terminal device, and the service requirement. For example, the mode value of the target OAM mode is [−4, −2, −1, 0, 1, 3]. That is to say, a final mode value actually transmitted may not necessarily be the same as the mode value recommended by the terminal device.

Step S303: a first signaling is sent to the terminal device, the first signaling being used for informing the terminal device that an OAM mode used by the physical downlink shared channel is the target OAM mode.

In an example, when determining the target OAM mode for transmitting the physical downlink shared channel, the network device may inform the terminal device through the first signaling that the OAM mode used by the physical downlink shared channel is the target OAM mode. The first signaling may be any one of downlink control information (DCI), a media access control (MAC)-control element (CE), or radio resource control (RRC).

Step S304: the physical downlink shared channel is transmitted according to the target OAM mode.

That is to say, the network device may inform the terminal device through the first signaling that the OAM mode used by the physical downlink shared channel is the target OAM mode, so that the physical downlink shared channel may be transmitted according to the target OAM mode.

By implementing the example of the disclosure, different transmission modes may be flexibly selected based on current channel information of the physical downlink shared channel to form a mode combination to bear physical downlink shared channel information, thus improving system reliability.

Please refer to FIG. 4, and FIG. 4 is a schematic flow diagram of yet another method for transmitting shared channel based on orbital angular momentum provided by an example of the disclosure. It needs to be noted that the method for transmitting shared channel based on orbital angular momentum of the example of the disclosure may be performed by a network device. The example of the disclosure is applied to a physical uplink shared channel scenario, that is, the example of the disclosure describes how to configure an OAM mode for a PUSCH. As shown in FIG. 4, the method may include, but is not limited to the following steps.

Step S401: current channel information is obtained by performing uplink channel estimation based on an uplink reference signal sent by a terminal device.

In some examples of the disclosure, the uplink reference signal may be a sounding reference symbol (SRS), or may also be other uplink reference signals, which is not specifically limited in the disclosure.

In an example, the terminal device sends the uplink reference signal, such as the SRS, to the network device for estimating an uplink shared channel. When receiving the uplink reference signal sent by the terminal device, the network device may perform uplink channel estimation to obtain current channel information of the physical uplink shared channel. In the example of the disclosure, the current channel information of the physical uplink shared channel may include a capability of the terminal device, and the capability of the terminal device may be understood as the maximum number of OAM modes that the terminal device may receive.

Step S402: a target OAM mode for transmitting the physical uplink shared channel is determined according to the current channel information and a network resource.

In an example, after performing uplink channel estimation based on the uplink reference signal sent by the terminal device, the network device may determine the target OAM mode for transmitting the physical uplink shared channel according to situations such as the capability of the terminal device in the current channel information, and the network resource.

In order to make the configured OAM mode more in line with the actual situation, in an example, the network device may determine the target OAM mode for transmitting the physical uplink shared channel according to the current channel information, the network resource and a service requirement. For example, the network device may determine an OAM mode used by the physical uplink shared channel according to the capability of the terminal device in the current channel information, the network resource and the service requirement. The capability of the terminal device may be understood as the maximum number of the OAM modes that the terminal device may receive. The network resource may be understood as scheduling of a multi-modal resource by the network device in consideration of multi-user communication. The service requirement may be understood as a need of the service for a speed and/or a block error rate (BLER).

Step S403: a second signaling is sent to the terminal device, the second signaling being used for instructing the terminal device to determine that a mode for transmitting the physical uplink shared channel is the target OAM mode.

In some examples of the disclosure, the second signaling may be any signaling of DCI, an MAC-CE, or RRC.

In an example, when determining the target OAM mode for transmitting the physical uplink shared channel, the network device may indicate the OAM mode used by the physical uplink shared channel to the terminal device through the second signaling. The second signaling sent by the network device to the terminal device may carry the mode number of the target OAM mode, or may carry a set of a mode value of the target OAM mode. In order to save signaling overheads, an index number may be set for each mode combination. In this way, the network device may send the index number of the mode combination of the target OAM mode to the terminal device through the second signaling, so that the terminal device understands which mode combination is the target OAM mode configured by the network device based on the index number.

Step S404: the physical uplink shared channel is transmitted according to the target OAM mode.

That is to say, the network device may inform the terminal device through the second signaling that the OAM mode used by the physical uplink shared channel is the target OAM mode, so that the physical uplink shared channel may be transmitted according to the target OAM mode.

By implementing the example of the disclosure, different transmission modes may be flexibly selected based on the current channel information of the physical uplink shared channel to form a mode combination to bear physical uplink shared channel information, thus improving the system reliability.

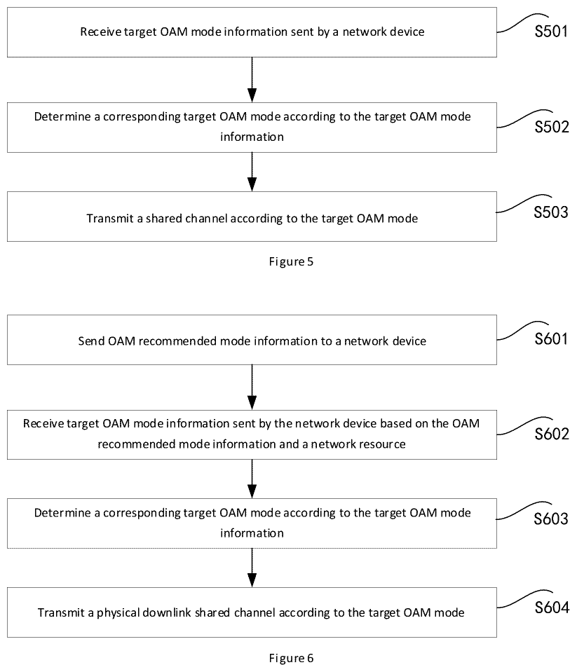

It may be understood that the above example describes the implementation of the method for transmitting shared channel based on orbital angular momentum of the example of the disclosure from a network device side. An example of the disclosure further provides a method for transmitting shared channel based on orbital angular momentum. The following will describe the implementation of the method for transmitting shared channel based on orbital angular momentum from a terminal device side. Please refer to FIG. 5, and FIG. 5 is a flow diagram of yet another method for transmitting shared channel based on orbital angular momentum provided by an example of the disclosure. It needs to be noted that the method for transmitting shared channel based on orbital angular momentum of the example of the disclosure may be performed by a terminal device. As shown in FIG. 5, the method for transmitting shared channel based on orbital angular momentum may include, but is not limited to the following steps.

Step S501: target OAM mode information sent by a network device is received.

The target OAM mode information may be determined based on current channel information.

In one example, the target OAM mode information may be OAM recommended mode information reported and suggested by the terminal device to the network device. The network device may determine the target OAM mode information according to the OAM recommended mode information reported and suggested by the terminal device and a network resource, or determine the target OAM mode information according to the OAM recommended mode information reported and suggested by the terminal device, a service requirement and the network resource. The network device may send the determined target OAM mode to the terminal device.

In another example, the network device may determine the target OAM mode information for transmitting a shared channel according to the current channel information obtained through uplink channel estimation, and send a determined target OAM mode to the terminal device.

Step S502: the corresponding target OAM mode is determined according to the target OAM mode information.

In an example, the target OAM mode information includes at least one of the following:
1) an OAM mode number and/or an OAM mode set; or
2) an OAM mode number and/or an index of the OAM mode set.

In the example of the disclosure, when receiving the target OAM mode information sent by the network device, the terminal device may determine an OAM mode actually used by the shared channel according to the target OAM mode information.

Step S503: the shared channel is transmitted according to the target OAM mode.

That is to say, when receiving the target OAM mode information sent by the network device, the terminal device may bear shared channel information according to the OAM mode corresponding to the target OAM mode information.

By implementing the example of the disclosure, different transmission modes may be flexibly selected based on the current channel information of the shared channel to form a mode combination to bear shared channel information, thus improving the system reliability.

It needs be noted that due to the fact that the shared channel is divided into a physical downlink shared channel (PDSCH) and a physical uplink shared channel (PUSCH), the configuration modes of the OAM mode may also vary for the different shared channels. In order to facilitate those skilled in the art having a clearer understanding of how to choose the appropriate mode combination as the transmission mode to meet the service requirements of the shared channel in the disclosure, the following will describe the physical downlink shared channel and the physical uplink shared channel respectively.

Please refer to FIG. 6, and FIG. 6 is a schematic flow diagram of another method for transmitting shared channel based on orbital angular momentum provided by an example of the disclosure. It needs to be noted that the method for transmitting shared channel based on orbital angular momentum of the example of the disclosure may be performed by a terminal device. The example of the disclosure is applied to a physical downlink shared channel scenario, that is, the example of the disclosure describes how to configure an OAM mode for a PDSCH. As shown in FIG. 6, the method may include, but is not limited to the following steps.

Step S601: OAM recommended mode information is sent to a network device.

In an example, the terminal device may receive a downlink reference signal sent by the network device, perform downlink channel estimation according to the downlink reference signal, determine OAM recommended mode information corresponding to current channel information, and send the OAM recommended mode information to the network device.

For example, the network device may send the downlink reference signal to the terminal device, and the downlink reference signal may be used for instructing the terminal device to perform downlink channel estimation to obtain the current channel information, and to select the OAM recommended mode information corresponding to the current channel information. The network device may receive the OAM recommended mode information reported by the terminal device. The downlink reference signal may be a CSI-RS, or other downlink reference signals, which is not specifically limited in the disclosure.

As an example, the network device may send the downlink reference signal, such as the CSI-RS. When receiving the downlink reference signal sent by the network device, the terminal device may use the downlink reference signal for channel estimation to obtain current channel information of the physical downlink shared channel, and may select the OAM recommended mode information that is suitable for the current channel information. The OAM recommended mode information may be understood as recommending the network device to use the OAM mode information to configure the OAM mode of the PDSCH, so that the configuration-based OAM mode carries the PDSCH information. The terminal device may send the OAM recommended mode information determined based on the current channel information to the network device, so that the network device may configure the OAM mode of the physical downlink shared channel by referring to the OAM recommended mode information sent by the terminal device.

In some examples of the disclosure, the OAM recommended mode information may include at least one of the following:
1) an OAM mode number and/or an OAM mode set; or
2) an OAM mode number and/or an index of the OAM mode set.

As an example, the OAM recommended mode information, recommended by the terminal device, received by the network device may be the OAM mode number, or may be the OAM mode set, or may further be the OAM mode number and the OAM mode set.

For example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select the OAM mode number n that is suitable for the current channel information. That is, the OAM mode number n is a mode number n recommended by the terminal device to the network device for transmission, n<N, where N is the number of antenna arrays at a transmitting end.

For another example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select an OAM mode value that is suitable for the current channel information. The OAM mode value is an OAM mode value recommended by the terminal device to the network device for use, for example, [−4, −3, −2, −1, 0, 1, 2, 3], and a set of the OAM mode value is the OAM mode set above.

In an example, the network device may send the downlink reference signal, such as the CSI-RS. When receiving the downlink reference signal sent by the network device, the terminal device may use the downlink reference signal for channel estimation to obtain the current channel information of the physical downlink shared channel, and may select the OAM mode number n and the OAM mode value that are suitable for the current channel information. The OAM mode number n is the mode number n recommended by the terminal device to the network device for transmission, n<N, where N is the number of the antenna arrays at the transmitting end. The OAM mode value is the OAM mode value recommended by the terminal device to the network device for use.

As another example, the OAM recommended mode information, recommended by the terminal device, received by the network device may be the OAM mode number, or may be the index of the OAM mode set, or may further be the OAM mode number and an index of the OAM mode set. To save signaling overheads, the index number may be set for each set of the OAM mode value. In this way, when the terminal device sends the OAM recommended mode information to the network device, an index corresponding to the OAM mode set recommended for use may be sent to the network device, so that the network device may understand which OAM mode set or sets are recommended to use by the terminal device based on the index.

In the example of the disclosure, the terminal device may send the OAM recommended mode information to the network device after estimating the channel information using the downlink reference signal and selecting the OAM recommended mode information that is suitable for the current channel information.

Step S602: the target OAM mode information sent by the network device based on the OAM recommended mode information and a network resource is received.

In an example, the terminal device may send the OAM recommended mode information to the network device. The network device may determine the target OAM mode for transmitting the physical downlink shared channel according to the network resource and the OAM mode information reported and suggested by the terminal device. The target OAM mode determined by the network device may not necessarily be the same as the OAM mode recommended by the terminal device.

In order to make the configured OAM mode more in line with the actual situation, in an example, the terminal device may receive the target OAM mode information sent by the network device based on the OAM recommended mode information, the network resource and a service requirement.

For example, the network device may determine the target OAM mode for transmitting the physical downlink shared channel according to the OAM recommended mode information, the network resource and the service requirement. That is to say, the network device may configure an OAM mode actually used by the physical downlink shared channel (PDSCH) according to the situations such as the OAM recommended mode information reported by the terminal device, the service requirement and the network resource. The network resource may be understood as scheduling of a multi-modal resource by the network device in consideration of multi-user communication. The service requirement may be understood as a need of the service for a speed and/or a block error rate (BLER).

That is to say, the network device determines the target OAM mode for transmitting physical downlink shared channel based on the scheduling situation of the multi-modal resource by the multi-user communication, the need of the service for the speed and/or the BLER, and the recommended OAM mode information reported and suggested by the terminal device.

For example, taking an example that the OAM mode value recommended by the terminal device to the network device for use is [−4, −3, −2, −1, 0, 1, 2, 3], the network device may determine the target OAM mode for transmitting the physical downlink shared channel according to the network resource, the OAM recommended mode information reported and suggested by the terminal device, and the service requirement. For example, the mode value of the target OAM mode is [−4, −2, −1, 0, 1, 3]. That is to say, a final mode value actually transmitted may not necessarily be the same as the mode value recommended by the terminal device.

In the example of the disclosure, when determining the target OAM mode for transmitting the physical downlink shared channel, the network device may inform the terminal device through the first signaling that the OAM mode used by the physical downlink shared channel is the target OAM mode. The first signaling may be any signaling of DCI, an MAC-CE, or RRC.

Step S603: the corresponding target OAM mode is determined according to the target OAM mode information.

In an example, the target OAM mode information includes at least one of the following:
1) the OAM mode number and/or the OAM mode set; or
2) an OAM mode number and/or an index of the OAM mode set.

In the example of the disclosure, when receiving the target OAM mode information sent by the network device, the terminal device may determine the OAM mode actually used by the shared channel according to the target OAM mode information.

Step S604: the physical downlink shared channel is transmitted according to the target OAM mode.

That is to say, when receiving the target OAM mode information sent by the network device, the terminal device may bear downlink shared channel information according to the OAM mode corresponding to the target OAM mode information.

By implementing the example of the disclosure, different transmission modes may be flexibly selected based on the current channel information of the downlink shared channel to form a mode combination to bear downlink shared channel information, thus improving the system reliability.

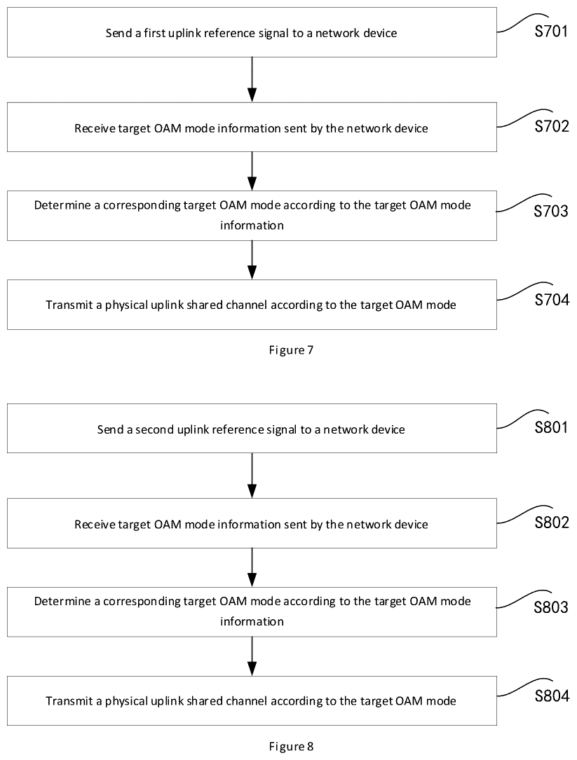

Please refer to FIG. 7, and FIG. 7 is a schematic flow diagram of yet another method for transmitting shared channel based on orbital angular momentum provided by an example of the disclosure. It needs to be noted that the method for transmitting shared channel based on orbital angular momentum of the example of the disclosure may be performed by a terminal device. The example of the disclosure is applied to a physical uplink shared channel scenario, that is, the example of the disclosure describes how to configure an OAM mode for a PUSCH. As shown in FIG. 7, the method may include, but is not limited to the following steps.

Step S701: a first uplink reference signal is sent to the network device.

In the example of the disclosure, the first uplink reference signal is used for instructing the network device to perform uplink channel estimation to obtain current channel information, and to determine target OAM mode information for transmitting the physical uplink shared channel according to the current channel information and a network resource. As an example, the first uplink reference signal may be an SRS or may also be other uplink reference signals, which is not specifically limited in the disclosure.

For example, the terminal device sends the first uplink reference signal, such as the SRS, to the network device for estimating the uplink shared channel. When receiving the first uplink reference signal sent by the terminal device, the network device may perform uplink channel estimation to obtain current channel information of the physical uplink shared channel. In the example of the disclosure, the current channel information of the physical uplink shared channel may include a capability of the terminal device, and the capability of the terminal device may be understood as the maximum number of OAM modes that the terminal device may receive. After performing uplink channel estimation based on the first uplink reference signal sent by the terminal device, the network device may determine the target OAM mode information for transmitting the physical uplink shared channel according to situations such as the capability of the terminal device in the current channel information, and the network resource.

Step S702: the target OAM mode information sent by the network device is received.

In an example, the network device may send the target OAM mode information to the terminal device through a second signaling. In some examples of the disclosure, the second signaling may be any signaling of DCI, an MAC-CE, or RRC. In an example, the target OAM mode information includes at least one of the following:
1) an OAM mode number and/or an OAM mode set; or
2) an OAM mode number and/or an index of the OAM mode set.

In an example, when determining a target OAM mode for transmitting the physical uplink shared channel, the network device may indicate the OAM mode used by the physical uplink shared channel to the terminal device through the second signaling. The second signaling sent by the network device to the terminal device may carry the mode number of the target OAM mode, or may carry a set of a mode value of the target OAM mode. In order to save signaling overheads, the index number may be set for each mode combination. In this way, the network device may send the index number of the mode combination of the target OAM mode to the terminal device through the second signaling, so that the terminal device understands which mode combination is the target OAM mode configured by the network device based on the index number.

Step S703: the corresponding target OAM mode is determined according to the target OAM mode information.

In the example of the disclosure, when receiving the target OAM mode information sent by the network device, the terminal device may determine an OAM mode actually used by the shared channel according to the target OAM mode information.

Step S704: the physical uplink shared channel is transmitted according to the target OAM mode.

That is to say, when receiving the target OAM mode information sent by the network device, the terminal device may bear uplink shared channel information according to the OAM mode corresponding to the target OAM mode information.

By implementing the example of the disclosure, different transmission modes may be flexibly selected based on the current channel information of the uplink shared channel to form the mode combination to bear uplink shared channel information, thus improving the system reliability.

Please refer to FIG. 8, and FIG. 8 is a schematic flow diagram of yet another method for transmitting shared channel based on orbital angular momentum provided by an example of the disclosure. It needs to be noted that the method for transmitting shared channel based on orbital angular momentum of the example of the disclosure may be performed by a terminal device. The example of the disclosure is applied to a physical uplink shared channel scenario, that is, the example of the disclosure describes how to configure an OAM mode for a PUSCH. As shown in FIG. 8, the method may include, but is not limited to the following steps.

Step S801: a second uplink reference signal is sent to a network device.

In the example of the disclosure, the second uplink reference signal is used for instructing the network device to perform uplink channel estimation to obtain current channel information, and to determine target OAM mode information for transmitting the physical uplink shared channel according to the current channel information, a network resource and a service requirement. As an example, the second uplink reference signal may be an SRS or other uplink reference signals, which is not specifically limited in the disclosure.

For example, the terminal device sends the second uplink reference signal, such as the SRS, to the network device for estimating the uplink shared channel. When receiving the second uplink reference signal sent by the terminal device, the network device may perform uplink channel estimation to obtain current channel information of the physical uplink shared channel. In the example of the disclosure, the current channel information of the physical uplink shared channel may include a capability of the terminal device, and the capability of the terminal device may be understood as the maximum number of OAM modes that the terminal device may receive. After performing uplink channel estimation based on the first uplink reference signal sent by the terminal device, the network device may determine the target OAM mode information for transmitting the physical uplink shared channel according to situations such as the capability of the terminal device in the current channel information, the service requirement and the network resource. Thus, the OAM mode used by the uplink shared channel may be made more in line with the actual situation.

Step S802: the target OAM mode information sent by the network device is received.

In an example, the network device may send the target OAM mode information to the terminal device through a second signaling. In some examples of the disclosure, the second signaling may be any signaling of DCI, an MAC-CE, or RRC. In an example, the target OAM mode information includes at least one of the following:
1) an OAM mode number and/or an OAM mode set; or
2) an OAM mode number and/or an index of the OAM mode set.

In an example, when determining a target OAM mode for transmitting the physical uplink shared channel, the network device may indicate the OAM mode used by the physical uplink shared channel to the terminal device through the second signaling. The second signaling sent by the network device to the terminal device may carry the mode number of the target OAM mode, or may carry a set of a mode value of the target OAM mode. In order to save signaling overheads, an index number may be set for each mode combination. In this way, the network device may send the index number of the mode combination of the target OAM mode to the terminal device through the second signaling, so that the terminal device understands which mode combination is the target OAM mode configured by the network device based on the index number.

Step S803: the corresponding target OAM mode is determined according to the target OAM mode information.

In the example of the disclosure, when receiving the target OAM mode information sent by the network device, the terminal device may determine an OAM mode actually used by the shared channel according to the target OAM mode information.

Step S804: the physical uplink shared channel is transmitted according to the target OAM mode.

That is to say, when receiving the target OAM mode information sent by the network device, the terminal device may bear uplink shared channel information according to the OAM mode corresponding to the target OAM mode information.

By implementing the example of the disclosure, different transmission modes may be flexibly selected based on the current channel information of the uplink shared channel to form the mode combination to bear uplink shared channel information, thus improving the system reliability.

In the above examples provided by the disclosure, the methods provided by the example of the disclosure are respectively introduced from the perspectives of the network device and the terminal device. In order to implement various functions in the methods provided by the examples of the disclosure, the network device and the terminal device may include a hardware structure and a software module, and the above various functions are implemented in the form of the hardware structure, the software module, or the hardware structure plus the software module. One of the above various functions may be executed in the form of the hardware structure, the software module, or the hardware structure plus the software module.

Please refer to FIG. 9, and FIG. 9 is a schematic structural diagram of a communication apparatus 90 provided by an example of the disclosure. The communication apparatus 90 shown in FIG. 9 may include a transceiving module 901 and a processing module 902. The transceiving module 901 may include a sending module and/or a receiving module. The sending module is configured to implement a sending function, the receiving module is configured to implement a receiving function, and the transceiving module 901 may implement the sending function and/or the receiving function.

The communication apparatus 90 may be a network device, or an apparatus in the network device, or an apparatus that can be used in cooperation with the network device. Or, the communication apparatus 90 may be a terminal device, or an apparatus in the terminal device, or an apparatus that can be used in cooperation with the terminal device.

The communication apparatus 90 is the network device: in the example of the disclosure, the processing module 902 is configured to determine, based on current channel information, a target orbital angular momentum (OAM) mode for transmitting a shared channel; and the processing module 902 is further configured to transmit the shared channel according to the target OAM mode.

In an example, in a case that the shared channel is a physical downlink shared channel, the transceiving module 901 is configured to receive OAM recommended mode information reported by the terminal device based on the current channel information, where the processing module 902 is configured to determine a target OAM mode for transmitting the physical downlink shared channel according to the OAM recommended mode information and a network resource.

In a possible example, the transceiving module 901 is configured to: send a downlink reference signal to the terminal device, the downlink reference signal being used for instructing the terminal device to perform downlink channel estimation to obtain the current channel information, and to select OAM recommended mode information corresponding to the current channel information; and receive the OAM recommended mode information reported by the terminal device.

In a possible example, the OAM recommended mode information includes at least one of the following: 1) an OAM mode number and/or an OAM mode set; or 2) an OAM mode number and/or an index of the OAM mode set.

In a possible example, the processing module 902 is configured to: determine the target OAM mode for transmitting the physical downlink shared channel according to the OAM recommended mode information, the network resource and a service requirement.

In a possible example, the transceiving module 901 is further configured to: send a first signaling to the terminal device, the first signaling being used for informing the terminal device that an OAM mode used by the physical downlink shared channel is the target OAM mode; and the processing module 902 is configured to: transmit the physical downlink shared channel according to the target OAM mode.

In an example, in a case that the shared channel is a physical uplink shared channel, the processing module 902 is configured to: obtain the current channel information by performing uplink channel estimation based on an uplink reference signal sent by the terminal device; and determine a target OAM mode for transmitting the physical uplink shared channel according to the current channel information and a network resource.

In a possible example, the processing module 902 is configured to: determine the target OAM mode for transmitting the physical uplink shared channel according to the current channel information, the network resource and a service requirement.

In a possible example, the transceiving module 901 is configured to send a second signaling to the terminal device, the second signaling being used for instructing the terminal device to determine that a mode for transmitting the physical uplink shared channel is the target OAM mode, where the processing module 902 is configured to transmit the physical uplink shared channel according to the target OAM mode.

The communication apparatus 90 is the network device: in the example of the disclosure, the transceiving module 901 is configured to receive target orbital angular momentum (OAM) mode information sent by the network device; and the processing module 902 is configured to determine a corresponding target OAM mode according to the target OAM mode information, and transmit a shared channel according to the target OAM mode.

In an example, in a case that the shared channel is a physical downlink shared channel, the transceiving module 901 is configured to: send OAM recommended mode information to the network device; and receive the target OAM mode information sent by the network device based on the OAM recommended mode information and a network resource.

In a possible example, the transceiving module 901 is further configured to receive a downlink reference signal sent by the network device; the processing module 902 is further configured to perform downlink channel estimation according to the downlink reference signal, and determine OAM recommended mode information corresponding to current channel information; and the transceiving module 901 is further configured to send the OAM recommended mode information to the network device.

In a possible example, the OAM recommended mode information includes at least one of the following: 1) an OAM mode number and/or an OAM mode set; or 2) an OAM mode number and/or an index of the OAM mode set.

In a possible example, the transceiving module 901 is configured to: receive the target OAM mode information sent by the network device based on the OAM recommended mode information, the network resource and a service requirement.

In a possible example, the processing module 902 is configured to: transmit the physical downlink shared channel according to the target OAM mode.

In an example, in a case that the shared channel is a physical uplink shared channel, the transceiving module 901 is configured to: send a first uplink reference signal to the network device, the first uplink reference signal being used for instructing the network device to perform uplink channel estimation to obtain current channel information, and to determine target OAM mode information for transmitting the physical uplink shared channel according to the current channel information and a network resource; and receive the target OAM mode information sent by the network device.

In an example, in a case that the shared channel is a physical uplink shared channel, the transceiving module 901 is configured to: send a second uplink reference signal to the network device, the second uplink reference signal being used for instructing the network device to perform uplink channel estimation to obtain current channel information, and to determine target OAM mode information for transmitting the physical uplink shared channel according to the current channel information, a network resource and a service requirement; and receive the target OAM mode information sent by the network device.

In a possible example, the processing module 902 is configured to: transmit the physical uplink shared channel according to the target OAM mode.

As for the apparatus in the above examples, the specific modes for executing operations by all the modules have been described in the examples related to the methods in detail, which is not illustrated in detail here.

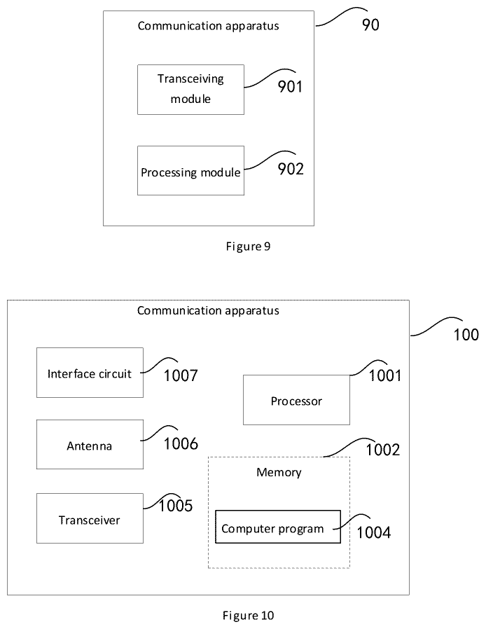

Please refer to FIG. 10, and FIG. 10 is a schematic structural diagram of another communication apparatus 100 provided by an example of the disclosure. The communication apparatus 100 may be a network device, may also be a terminal device, may also be a chip, a system on a chip, or a processor that supports the network device to implement the methods above, and may further be a chip, a system on a chip, or a processor that supports the terminal device to implement the methods above. This apparatus may be configured to implement the methods described in the above method examples, which may specifically refer to illustration in the above method examples.

The communication apparatus 100 may include one or more processors 1001. The processor 1001 may be a general-purpose processor or a dedicated processor. For example, it may be a baseband processor or a central processing unit. The baseband processor may be configured to process a communication protocol and communication data, while the central processing unit may be used for controlling the communication apparatus (such as a base station, a baseband chip, the terminal device, a terminal device chip, and a DU or CU), execute a computer program, and process data from the computer program.

In an example, the communication apparatus 100 may further include one or more memories 1002 on which a computer program 1004 may be stored, and the processor 1001 executes the computer program 1004 to cause the communication apparatus 100 to execute the methods described in the above method examples. In an example, the memory 1002 may further store data. The communication apparatus 100 and the memory 1002 may be arranged separately or integrated together.

In an example, the communication apparatus 100 may further include a transceiver 1005 and an antenna 1006. The transceiver 1005 may be referred to as a transceiving unit, a transceiving machine, or a transceiving circuit, etc., configured to achieve a transceiving function. The transceiver 1005 may include a receiver and a transmitter, and the receiver may be referred to as a receiving machine or a receiving circuit, configured to receive a receiving function; and the transmitter may be referred to as a transmitting machine or a transmitting circuit, configured to achieve a transmitting function.

In an example, the communication apparatus 100 may further include one or more interface circuits 1007. The interface circuit 1007 is configured to receive code instructions and transmit the code instructions to the processor 1001. The processor 1001 runs the code instructions to cause the communication apparatus 100 to execute the methods described in the above method examples.

The communication apparatus 100 is the network device: the processor 1001 is configured to execute step S201 and step S202 in FIG. 2, execute step S302 and step S304 in FIG. 3, and execute step S401, step S402 and step S404 in FIG. 4. The transceiver 1005 is configured to execute step S301 and step S303 in FIG. 3 and step S403 in FIG. 4.

The communication apparatus 100 is the terminal device: the transceiver 1005 is configured to execute step S501 in FIG. 5, execute step S601 and step S602 in FIG. 6, execute step S701 and step S702 in FIG. 7, and execute step S801 and step S802 in FIG. 8. The processor 1001 is configured to execute step S502 and step S503 in FIG. 5, execute step S603 and step S604 in FIG. 6, execute step S703 and step S704 in FIG. 7, and execute step S803 and step S804 in FIG. 8.

In one example, the processor 1001 may include a transceiver for implementing receiving and transmitting functions. For example, the transceiver may be a transceiving circuit, an interface, or an interface circuit. The transceiving circuit, interface, or interface circuit configured to achieve the receiving and transmitting functions may be separate or integrated together. The above transceiving circuit, interface, or interface circuit may be configured to read and write codes/data, or the above transceiving circuit, interface, or interface circuit may be configured to transmit or transfer signals.

In one example, the processor 1001 may store a computer program 1003, the computer program 1003 runs on the processor 1001, to cause the communication apparatus 100 to execute the methods described in the above method examples. The computer program 1003 may be solidified in the processor 1001, in which case the processor 1001 may be implemented by hardware.

In an example, the communication apparatus 100 may include a circuit, and the circuit may achieve the functions of transmitting, receiving, or communicating in the aforementioned method examples. The processor and the transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication apparatus described in the above examples may be the network device or the terminal device, but the scope of the communication apparatus described in the disclosure is not limited to this. The structure of the communication apparatus may be not limited by FIG. 10. The communication apparatus may be an independent device or may be part of a larger device. For example, the communication apparatus may be:
(1) an independent integrated circuit (IC), or a chip, or a system on a chip or a subsystem;
(2) a set with one or more ICs, In an example, the IC set including a storage component for storing data and a computer program;
(3) an ASIC, such as a modem;
(4) a module that can be embedded in other devices;
(5) a receiving machine, the terminal device, an intelligent terminal device, a cellular phone, a wireless device, a handheld machine, a mobile unit, an on-board device, the network device, a cloud device, an artificial intelligence devices, etc.; and
(6) others and so on.

Those skilled in the art can further understand that various illustrative logical blocks and steps listed in the examples of the disclosure may be implemented through electronic hardware, computer software, or a combination of the two. Whether such functions are implemented through the hardware or the software depends on the specific application and design demands of the overall system. Those skilled in the art can use various methods to achieve the described functions for each specific application, but such implementation is not understood as exceeding the scope of protection of the example of the disclosure.

An example of the disclosure further provides a system for determining a sidelink duration. The system includes the communication apparatus as the terminal device and the communication apparatus as the network device in the aforementioned example of FIG. 9, or the system includes the communication apparatus as the terminal device and the communication apparatus as the network device in the aforementioned example of FIG. 10.

The disclosure further provides a readable storage medium on which instructions are stored, and the instructions, when performed by a computer, implement the functions of any of the above method examples.

The disclosure further provides a computer program product, and the computer program product, when performed by a computer, implements the functions of any of the above method examples.

In the above examples, it can be fully or partially implemented through software, hardware, firmware, or any combination of them. When implemented using the software, it can be fully or partially implemented in a form of the computer program product. The computer program product includes one or more computer programs. When loading and executing the computer program on the computer, processes or functions described according to the examples of the disclosure are fully or partially generated. The computer may be a general-purpose computer, a dedicated computer, a computer network, or other programmable apparatuses. The computer program may be stored in a computer-readable storage medium or transmitted from one computer-readable storage medium to another. For example, the computer program may be transmitted from a website, a computer, a server or a data center to another website, computer, server, or data center through a wired (such as a coaxial cable, an optical fiber, a digital subscriber line (DSL)) or wireless (such as infrared, wireless, and microwave) mode. The computer-readable storage medium may be any available medium that the computer can access, or a data storage device such as a server or a data center that is integrated by one or more available media. The available medium may be a magnetic medium (such as a floppy disk, a hard drive, and a magnetic tape), an optical medium (such as a high-density digital video disc (DVD)), or a semiconductor medium (such as a solid state disk (SSD)), etc.

In a first aspect, an example of the disclosure provides a method for transmitting shared channel based on orbital angular momentum, performed by a network device, and including:
determining, based on current channel information, a target orbital angular momentum (OAM) mode for transmitting a shared channel; and
transmitting the shared channel according to the target OAM mode.

In this technical solution, different transmission modes may be flexibly selected based on the current channel information to form a mode combination to bear shared channel information, thus improving system reliability.

In an example, the shared channel is a physical downlink shared channel; and determining, based on the current channel information, the target orbital angular momentum (OAM) mode for transmitting the shared channel includes: receiving OAM recommended mode information reported by a terminal device based on the current channel information; and determining a target OAM mode for transmitting the physical downlink shared channel according to the OAM recommended mode information and a network resource.

In a possible example, receiving the OAM recommended mode information reported by the terminal device based on the current channel information includes:
sending a downlink reference signal to the terminal device, the downlink reference signal being used for instructing the terminal device to perform downlink channel estimation to obtain the current channel information, and to select OAM recommended mode information corresponding to the current channel information; and
receiving the OAM recommended mode information reported by the terminal device.

In a possible example, the OAM recommended mode information includes at least one of the following:
1) an OAM mode number and/or an OAM mode set; or
2) an OAM mode number and/or an index of the OAM mode set.

In a possible example, determining the target OAM mode for transmitting the physical downlink shared channel according to the OAM recommended mode information and the network resource includes: determining the target OAM mode for transmitting the physical downlink shared channel according to the OAM recommended mode information, the network resource and a service requirement.

In a possible example, transmitting the shared channel according to the target OAM mode includes:
sending a first signaling to the terminal device, the first signaling being used for informing the terminal device that an OAM mode used by the physical downlink shared channel is the target OAM mode; and
transmitting the physical downlink shared channel according to the target OAM mode.

In an example, the shared channel is a physical uplink shared channel; and determining, based on the current channel information, the target orbital angular momentum (OAM) mode for transmitting the shared channel includes:
obtaining the current channel information by performing uplink channel estimation based on an uplink reference signal sent by the terminal device; and
determining a target OAM mode for transmitting the physical uplink shared channel according to the current channel information and a network resource.

In a possible example, determining the target OAM mode for transmitting the physical uplink shared channel according to the current channel information and the network resource includes: determining the target OAM mode for transmitting the physical uplink shared channel according to the current channel information, the network resource and a service requirement.

In a possible example, transmitting the shared channel according to the target OAM mode includes:
sending a second signaling to the terminal device, the second signaling being used for instructing the terminal device to determine that a mode for transmitting the physical uplink shared channel is the target OAM mode; and
transmitting the physical uplink shared channel according to the target OAM mode.

In a second aspect, an example of the disclosure provides another method for transmitting shared channel based on orbital angular momentum, performed by a terminal device, and including:
receiving target orbital angular momentum (OAM) mode information sent by a network device;
determining a corresponding target OAM mode according to the corresponding target OAM mode information; and
transmitting a shared channel according to the target OAM mode.

In this technical solution, different transmission modes may be flexibly selected based on the current channel information to form a mode combination to bear shared channel information, thus improving system reliability.

In an example, the shared channel is a physical downlink shared channel; and receiving the target orbital angular momentum (OAM) mode information sent by the network device includes: sending OAM recommended mode information to the network device; and receiving the target OAM mode information sent by the network device based on the OAM recommended mode information and a network resource.

In a possible example, sending the OAM recommended mode information to the network device includes: receiving a downlink reference signal sent by the network device; performing downlink channel estimation according to the downlink reference signal, and determining OAM recommended mode information corresponding to current channel information; and sending the OAM recommended mode information to the network device.

In a possible example, the OAM recommended mode information includes at least one of the following:
1) an OAM mode number and/or an OAM mode set; or
2) an OAM mode number and/or an index of the OAM mode set.

In a possible example, receiving the target OAM mode information sent by the network device based on the OAM recommended mode information and the network resource includes: receiving the target OAM mode information sent by the network device based on the OAM recommended mode information, the network resource and a service requirement.

In a possible example, transmitting the shared channel according to the corresponding target OAM mode includes: transmitting the physical downlink shared channel according to the target OAM mode.

In an example, the shared channel is a physical uplink shared channel; and receiving the target OAM mode information sent by the network device includes:
sending a first uplink reference signal to the network device, the first uplink reference signal being used for instructing the network device to perform uplink channel estimation to obtain current channel information, and the network device determining target OAM mode information for transmitting the physical uplink shared channel according to the current channel information and a network resource; and
receiving the target OAM mode information sent by the network device.

In an example, the shared channel is a physical uplink shared channel; and receiving the target OAM mode information sent by the network device includes:
sending a second uplink reference signal to the network device, the second uplink reference signal being used for instructing the network device to perform uplink channel estimation to obtain current channel information, and to determine target OAM mode information for transmitting the physical uplink shared channel according to the current channel information, a network resource and a service requirement; and
receiving the target OAM mode information sent by the network device.

In a possible example, transmitting the shared channel according to the corresponding target OAM mode includes: transmitting the physical uplink shared channel according to the corresponding target OAM mode.

Those ordinarily skilled in the art may understand that first, second, and other numerical numbers involved in the disclosure are merely differentiation for the convenience of description, and are not intended to limit the scope of the examples of the present disclosure, but also indicate the sequential order.

At least one in the disclosure may further be described as one or more, and a plurality of may be two, three, four, or more, which is not limited in the disclosure. In the examples of the disclosure, for a technical feature, the technical features described in the technical feature are distinguished by “first”, “second”, “third”, “A”, “B”, “C”, and “D”, and the technical features described by the “first”, “second”, “third”, “A”, “B”, “C”, and “D” have no any sequential order or order of size.

The corresponding relationships shown in various tables in the disclosure may be configured or may also be predefined. Values of information in each table are merely examples and may be configured as other values, which is not limited in the disclosure. When configuring the corresponding relationships between the information and various parameters, it does not need to configure all the corresponding relationships shown in each table. For example, in the tables in the disclosure, the corresponding relationships shown in certain rows may not be configured. For another example, appropriate deformation and adjustments, such as splitting and merging, may be made based on the above tables. Names of parameters shown in titles of the above tables may also use other names that can be understood by the communication apparatus, and the values or representations of the parameters may also be other values or representations understood by the communication apparatus. When the above tables are implemented, other data structures may also be used, such as an array, a queue, a container, a stack, a linear table, a pointer, a linked list, a tree, a graph, a structure, a class, a heap, a hashing table, or a hash table.

Predefinition in the disclosure may be understood as definition, predefinition, storage, pre-storage, pre-negotiation, pre-configuration, curing, or pre-firing.

Those ordinarily skilled in the art may realize that, units and algorithm steps of the examples described in the disclosed examples here can be implemented by electronic hardware, or a combination of the computer software and the electronic hardware. Whether these functions are executed in a mode of the hardware or the software depends on particular applications and design constraint conditions of the technical solutions. Professional technicians may use different methods to implement the described functions for each particular application, but such implementation is not to be regarded beyond the scope of the disclosure.

Those skilled in the art may clearly understand that, for the convenience and simplicity of description, a specific working process of the above described system, apparatus and unit may refer to the corresponding process in the aforementioned method examples, and will not be repeated here.

The above is merely a specific implementation of the disclosure, but the scope of protection of the disclosure is not limited to this. Changes or replacements that may be easily thought of by technical personnel familiar with the technical field within the technical scope disclosed in the disclosure need to be covered within the scope of protection of the disclosure. Thus, the scope of the protection of the disclosure needs to be subjected to the scope of protection of the claims.

1. A method for transmitting shared channel based on orbital angular momentum, performed by a network device, and comprising:
determining, based on current channel information, a target orbital angular momentum (OAM) mode for transmitting a shared channel; and
transmitting the shared channel according to the target OAM mode.

2. The method according to claim 1, wherein the shared channel is a physical downlink shared channel; and determining, based on the current channel information, the target orbital angular momentum (OAM) mode for transmitting the shared channel comprises:
receiving OAM recommended mode information reported by a terminal device based on the current channel information; and
determining a target OAM mode for transmitting the physical downlink shared channel according to the OAM recommended mode information and a network resource.

3. The method according to claim 2, wherein receiving the OAM recommended mode information reported by the terminal device based on the current channel information comprises:
sending a downlink reference signal to the terminal device, the downlink reference signal being used for instructing the terminal device to perform downlink channel estimation to obtain the current channel information, and to select OAM recommended mode information corresponding to the current channel information; and
receiving the OAM recommended mode information reported by the terminal device.

4. The method according to claim 2, wherein the OAM recommended mode information comprises at least one of the following:
1) an OAM mode number and/or an OAM mode set; or
2) an OAM mode number and/or an index of the OAM mode set.

5. The method according to claim 2, wherein determining the target OAM mode for transmitting the physical downlink shared channel according to the OAM recommended mode information and the network resource comprises:
determining the target OAM mode for transmitting the physical downlink shared channel according to the OAM recommended mode information, the network resource and a service requirement.

6. The method according to claim 2, wherein transmitting the shared channel according to the target OAM mode comprises:
sending a first signaling to the terminal device, the first signaling being used for informing the terminal device that an OAM mode used by the physical downlink shared channel is the target OAM mode; and
transmitting the physical downlink shared channel according to the target OAM mode.

7. The method according to claim 1, wherein the shared channel is a physical uplink shared channel; and determining, based on the current channel information, the target orbital angular momentum (OAM) mode for transmitting the shared channel comprises:
obtaining the current channel information by performing uplink channel estimation based on an uplink reference signal sent by a terminal device; and
determining a target OAM mode for transmitting the physical uplink shared channel according to the current channel information and a network resource.

8. The method according to claim 7, wherein determining the target OAM mode for transmitting the physical uplink shared channel according to the current channel information and the network resource comprises:
determining the target OAM mode for transmitting the physical uplink shared channel according to the current channel information, the network resource and a service requirement.

9. The method according to claim 7, wherein transmitting the shared channel according to the target OAM mode comprises:
sending a second signaling to the terminal device, the second signaling being used for instructing the terminal device to determine that a mode for transmitting the physical uplink shared channel is the target OAM mode; and
transmitting the physical uplink shared channel according to the target OAM mode.

10. A method for transmitting shared channel based on orbital angular momentum, performed by a terminal device, and comprising:
receiving target orbital angular momentum (OAM) mode information sent by a network device;
determining a corresponding target OAM mode according to the target OAM mode information; and
transmitting the shared channel according to the corresponding target OAM mode.

11. The method according to claim 10, wherein the shared channel is a physical downlink shared channel; and receiving the target orbital angular momentum (OAM) mode information sent by the network device comprises:
sending OAM recommended mode information to the network device; and
receiving the target OAM mode information sent by the network device based on the OAM recommended mode information and a network resource.

12. The method according to claim 11, wherein sending the OAM recommended mode information to the network device comprises:
receiving a downlink reference signal sent by the network device;
performing downlink channel estimation according to the downlink reference signal, and determining OAM recommended mode information corresponding to current channel information; and
sending the OAM recommended mode information to the network device.

13. The method according to claim 11, wherein the OAM recommended mode information comprises at least one of the following:
1) an OAM mode number and/or an OAM mode set; or
2) an OAM mode number and/or an index of the OAM mode set.

14. The method according to claim 11, wherein receiving the target OAM mode information sent by the network device based on the OAM recommended mode information and the network resource comprises:
receiving the target OAM mode information sent by the network device based on the OAM recommended mode information, the network resource and a service requirement.

15. The method according to claim 11, wherein transmitting the shared channel according to the corresponding target OAM mode comprises:
transmitting the physical downlink shared channel according to the target OAM mode.

16. The method according to claim 10, wherein the shared channel is a physical uplink shared channel; and receiving the target OAM mode information sent by the network device comprises:
sending a first uplink reference signal to the network device, the first uplink reference signal being used for instructing the network device to perform uplink channel estimation to obtain current channel information, and to determine target OAM mode information for transmitting the physical uplink shared channel according to the current channel information and a network resource; and
receiving the target OAM mode information sent by the network device.

17. The method according to claim 10, wherein the shared channel is a physical uplink shared channel; and receiving the target OAM mode information sent by the network device comprises:
sending a second uplink reference signal to the network device, the second uplink reference signal being used for instructing the network device to perform uplink channel estimation to obtain current channel information, and to determine target OAM mode information for transmitting the physical uplink shared channel according to the current channel information, a network resource and a service requirement; and
receiving the target OAM mode information sent by the network device.

18. The method according to claim 16, wherein transmitting the shared channel according to the corresponding target OAM mode comprises:
transmitting the physical uplink shared channel according to the corresponding target OAM mode.

19.-36. (canceled)

37. A communication apparatus, comprising a processor and a memory, wherein the memory stores a computer program, and the processor executes the computer program stored in the memory to cause the communication apparatus to perform the method according to claim 1.

38. A communication apparatus, comprising a processor and a memory, wherein the memory stores a computer program, and the processor executes the computer program stored in the memory to cause the communication apparatus to perform:
receiving target orbital angular momentum (OAM) mode information sent by a network device;
determining a corresponding target OAM mode according to the target OAM mode information; and
transmitting a shared channel according to the corresponding target OAM mode.

39. (canceled)

40. (canceled)
